(19) United States
(12) Patent Application Publication
(10) Pub. No.: US 2018/0247426 A1
(43) Pub. Date: Aug. 30, 2018

(54) SYSTEM FOR ACCURATE REMOTE MEASUREMENT

(71) Applicants: LAWRENCE GLUCK, Thousand Oaks, CA (US); JONATHAN GLUCK, Thousand Oaks, CA (US); DENNIS GLUCK, Thousand Oaks, CA (US); JOSEPH GLUCK, Thousand Oaks, CA (US)

(72) Inventors: LAWRENCE GLUCK, Thousand Oaks, CA (US); JONATHAN GLUCK, Thousand Oaks, CA (US); DENNIS GLUCK, Thousand Oaks, CA (US); JOSEPH GLUCK, Thousand Oaks, CA (US)

(21) Appl. No.: 15/755,691

(22) PCT Filed: Aug. 26, 2016
(86) PCT No.: PCT/US16/49115

§ 371 Date: Feb. 27, 2018

Related U.S. Application Data
(60) Provisional application No. 62/211,666, filed on Aug. 28, 2015.

(51) Int. Cl. G06T 7/62; G06Q 30/06; G06T 17/10; G06T 19/20; G06K 9/00

(52) U.S. Cl. CPC G06T 7/62; G06Q 30/0623; G06Q 30/0643; G06T 2219/2021; G06T 19/20; G06K 9/00664; G06T 17/10

(57) ABSTRACT

A method for accurate and remote user measurement includes receiving (step 102), by a server having a processor and addressable memory, a first image and a first image data from a smartphone, wherein the first image contains a system-predetermined reference object and at least a portion of a user, identifying (step 108), by the server, the system-predetermined reference object in the first image, determining (step 112), by the server, a first reference dimension of the identified system-predetermined reference object in the first image, and determining (step 114), by the server, at least one measurement of the user based on the determined first reference dimension.

### RELATED APPLICATIONS

This application claims priority to U.S. Provisional application No. 62/211,666 filed Aug. 28, 2015.

### FIELD OF THE INVENTION

The invention relates to measurements, and more particularly to clothing measurements.

### BACKGROUND

There has been a sharp increase over the last decade in online sales of almost every commodity. The explosion in online purchasing of apparel, shoes, and home décor items has vastly expanded the choice and range of available items. One results of this boom in online purchasing is the relatively high rate of online returns. The Wall Street Journal estimates apparel returns at over 33%. Poor fitting is the primary cause for most returns. Customers are unlikely, or unwilling, to measure all of their different length and perimeter dimensions necessary for proper fitting. Further, there are typically no standard or de facto standards for many typical sizing requirements, such as S, M, and L size labeling for T-shirts. For example, a size “Large” T-shirt from one manufacturer may be larger or smaller than a size “Large” T-shirt from another manufacture, possibly resulting in an unsatisfied customer and a potential return.

### SUMMARY

A method includes receiving, by a server having a processor and addressable memory, a first image and a first image data from a smartphone, wherein the first image contains a system-predetermined reference object and at least a portion of a user, identifying, by the server, the system-predetermined reference object in the first image, determining, by the server, a first reference dimension of the identified system-predetermined reference object in the first image, and determining, by the server, at least one measurement of the user based on the determined first reference dimension. The system-predetermined reference object may be a smartphone that created the first image. The method may also include receiving, by the server, a second image from the smartphone, wherein the second image contains the smartphone that created the second image and at least a portion of the user, determining, by the server, a second reference dimension of the identified smartphone in the second image and determining, by the server, at least one measurement of the user based on the determined second reference dimension. The first image may include at least one of: a selfie of the user containing a front view of the user's torso, a selfie of the user containing a side view of the user's torso, a selfie of the user containing a front view of the user's foot, and a selfie of the user containing a side view of the user's foot. The method may also include taking, by the smartphone of the user, the first image with the smartphone. Identifying the smartphone may be based on the first image data, with the first image data including the identity of the smartphone selected by the user. The first image data may include metadata identifying the smartphone model. In some embodiments, determining the first reference dimension of the identified smartphone in the first image also includes identifying, by the server, a smartphone measurement in the first image, referencing, by the server, a device database for a measurement corresponding to the identified smartphone measurement, and setting, by the server, the identified smartphone measurement as the first reference dimension based on the referenced device database measurement. In other embodiments, determining at least one measurement of the user based on the determined first reference dimension may also include calculating, by the server, an ellipsoid circumference of the user via a Sykora approximation. The determined at least one measurement of the user may be at least one of: a chest measurement, a waist measurement, a sleeve length, a pants inseam, a foot length, and a foot arc. The at least one measurement of the user may be sent to a third-party retailer. The at least one measurement of the user may be sent to the smartphone.

Another method includes taking front and side smartphone photos of a user's foot, the front and side smartphone images including an image of a system-predetermined reference object, and taking a photo that includes a bottom view of the user's foot. Additionally, the method may include identifying the system-predetermined reference object, determining a reference dimension for the system-predetermined reference object, and determining at least one measurement of the user foot based on the determined reference dimension. The method may also include selecting a best-fit idealized 3-D foot model in response to the at least one measurement and re-shaping the selected idealized 3-D foot model to fit the at least one measurement to create a user foot template. In certain embodiments, the method may include providing the user foot template to an additive manufacturing tool and manufacturing a footwear article that is sized to fit the user foot template.

### BRIEF DESCRIPTION OF DRAWINGS

The components in the figures are not necessarily to scale, emphasis instead being placed upon illustrating the principals of the invention. Like reference numerals designate corresponding parts throughout the different views. Embodiments are illustrated by way of example and not limitation in the figures of the accompanying drawings, in which:

FIG. 1 depicts a flowchart of an exemplary method of obtaining accurate remote measurements;

FIG. 2 depicts two exemplary photo positions for remotely determining the measurements for fitting a men's polo shirt;

FIGS. 3A and 3B depict front and rear sides of a smartphone;

FIGS. 4A, 4B and 4C depict side, front perspective bottom views of a user's foot that may be used to remotely determine the measurements of a man's foot for proper shoe sizing;

FIG. 5 is a flow-diagram of one embodiment of a method of obtaining accurate remote measurements of a user's foot for use in making an on-line purchase of footwear;

FIG. 6 is a flow-diagram describing one embodiment of a method of building a 3-D model of a user's foot for use in manufacturing custom footwear;

FIG. 7 depicts one embodiment of an idealized 3-D model of a foot;

FIG. 8 depicts five exemplary standard idealized foot types for use in creating idealized 3-D foot models;

FIG. 9 depicts a photo with a reference object that may be used to remotely determine a reference dimension of the reference object in order to remotely determine a user's measurements;

FIG. 10 depicts a sample database for determining the dimensions of a reference dimension of an identified smartphone or other object; and

FIG. 11 depicts one embodiment of a smartphone in communication with a server either through the Internet (i.e., a remote server) or locally.

### DETAILED DESCRIPTION

The present exemplary device, system, and method allows for accurate remote measurement of one or more body size measurements to aid in the purchase of apparel, footwear and other items requiring accurate item sizing. A user takes one or more selfies which include: the smartphone taking the picture, at least a portion of the user to be remotely measured, and image data. These one or more selfies are sent to a remote server, and, in one embodiment, the server identifies the smartphone in the picture, determines a scaling reference dimension of the smartphone, and determines the item sizing based on the reference dimension and one or more determined user measurements.

The remote server may receive or determine measurement data to compute the circumference of complex and irregular body dimensions such as a user waist size, chest size, thigh, finger, neck size, and other dimensions that are relevant to an item's purchase. Measurement data may also be used to determine best case estimates for judging some hard to define parameters such as the arch of a foot. The measurement data may be used to determine size and fit data for comparison to a database of a vendor's available inventory. The determined size and fit data may make buying apparel and footwear, home décor, jewelry and other items sold by size easier and more reliable. The remote server may use a mirrored selfie taken with a smart device, e.g., a mobile phone, tablet, netbook, laptop, smart watch, etc., in order to determine the smart device overall dimensions, or its display dimensions, as a reference dimension. As used herein, the word “smartphone” is intended to encompass a “smart device.” The measurement data and subsequent analysis allow an end user to determine a more accurate measurement of other objects in the same image such as foot size, waist size, pants inseam, neck size, finger size, etc., which will allow more accurate fit for items purchased online.

Additionally, in circumstances where it is not convenient, or practical, to take a mirrored selfie, an image containing a smartphone or another agreed upon object, e.g., a ruler, beverage container, copy paper, etc., may be used as a referenced standard. This allows for the accurate measurement of fitted home décor items, e.g., window treatments, slipcovers, etc., for the online purchase of properly sized products.

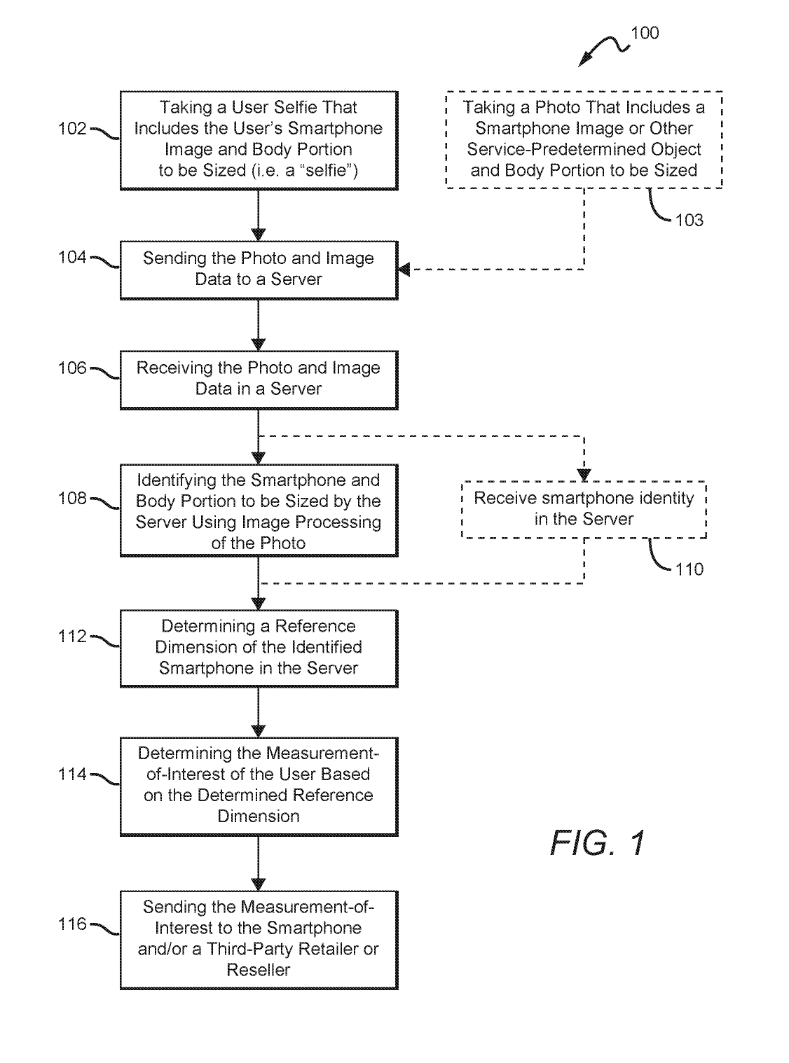

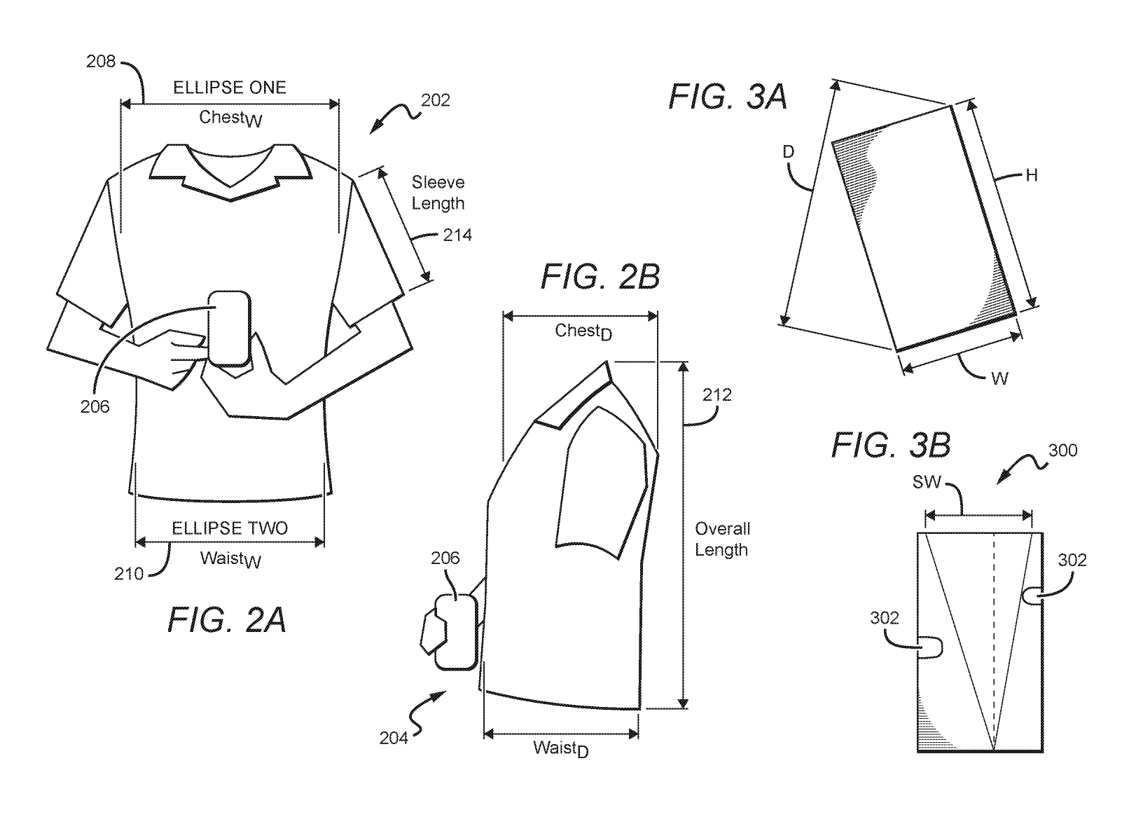

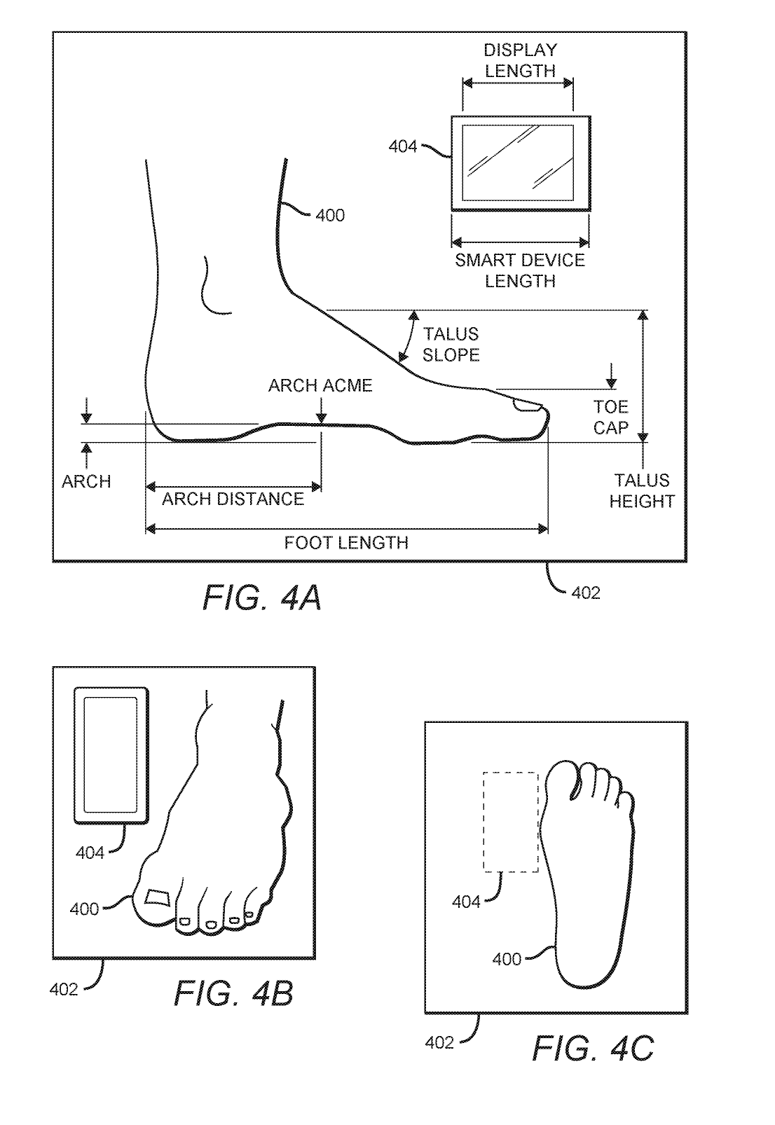

FIG. 1 is a flowchart of an exemplary method of obtaining accurate remote measurements 100 for use in making an on-line purchase. The exemplary method 100 may include taking a photo that includes a system pre-determined reference object such as the user's smartphone and the portion of the user's body that is to be fitted or otherwise sized (step 102), such as by taking a “selfie” in a mirror. The photo may be taken or retrieved using a smartphone application that is operable to upload one or more photos to a local computer or remote server for further processing. Although referred to as a “smartphone application,” such program code may be implemented through the use of multiple complementary applications, or through program instructions on other computing platforms, such as on a personal computer, tablet or more traditional digital camera. The smartphone application may have guides to assist a user in framing their photo and/or one or more prompts to instruct the user. The one or more photos may include different portions of the user that would collectively help to determine sizing for a to-be-purchased article, e.g., a front and side view of a user's torso (See FIG. 2), or different parts of the body, e.g., one or more image of a foot (FIG. 4). The exemplary method 100 may then include sending, by the smartphone, the taken one or more photos of the user and the received image data (step 104) for receipt by a server for processing (step 106). In an alternative embodiment, the user may take a phone from a web cam or from their smartphone of the body portion to be sized and another cell phone or service-predetermined object (step 103) that would be recognized by the method 100.

The exemplary method 100 may then include identifying, by the server, the smartphone and body portion to be sized in the received one or more photos (step 108) using image post processing. In another embodiment, the server does not locate and identify the smartphone in the image, but rather receives information identifying the smartphone as provided in the image data, such as in the image metadata (step 110), and merely locates the smartphone in the associated pre-determined reference object database. For example, the smartphone application may have access to the user's smartphone information at the time of taking the selfie in order to automatically include the smartphone model in the image data, such as in the image file metadata. In other embodiments, the smartphone application may prompt the user to enter their smartphone model, to select their smartphone model from a list, or to select a universal item of known dimension, such as 8½ inch by 11½ inch paper or 12-inch ruler, for inclusion in the image data. The smartphone may be detected and identified via cross referencing the received image data, e.g., via a user input, image metadata, and/or information taken from a smartphone application with a database of phones and associated phone dimensions called by the server. In all embodiments of the process, the uploaded image(s) submitted to a computer or server with proprietary software designed to detect the presence and location of both the smart device and the relevant part of the body to be measured. Though the particular body part (foot, chest and arms, waist and legs) may vary from one custom application to another, the underlying optical technology goals remain the same. The smart device and relevant body part must be detected.

Detection of the smartphone and body portion involves various optical algorithms which are designed and trained for their optical applicability to the task at hand. One such optical method used is a Haar Cascade or sometimes referred to as a Transform. In this process, a large number of images containing the particular body part or smart device are submitted to an optical algorithm. Many variations of lighting, background, focal length and subject matter (multiple feet from many individuals is one example) are submitted to this self-learning algorithm. Through constant correction of false positives and negatives, the algorithm learns to detect the object desired. The algorithm then submits coordinates defining the exact location of the desired object to the next stage of the software. There are other possible detection methods such as the so-called neural networks or deep learning methods. Such convolutional neural networks such as a Caffe are more graphically and computationally demanding but respond to larger variations in the object appearance. Once detection is completed and bounding box location coordinates are sent on to the next stage in image processing, the process of segmentation begins.

Segmentation is the process in which both the smart device and relevant body part in the image are located, scanned, the exact boundaries and edges mapped, scaled to the known dimension of the smart device and precisely measured. The segmentation algorithm finds the smart phone and body part by immediately looking within the detection bounding boxes forwarded by the detection algorithm. Using various and multiple methods of optical edge, color and shape discriminators, an exact outline of the foot and smart device is determined. Knowing the precise size of the smart device, it can be used as a reference standard to determine the other dimensions in the image. In one example implementation, binarization of the foot image may include:
a) cropping the region of interest (ROI) using the bounding box detection result;
b) converting the RGB image into an Crbrc system;
c) in the Cr channel, finding the threshold (e.g., using the Otsu method which performs cluster-based binary separation of pixels into two classes);
d) using the threshold to binarize the image;
e) clean/smooth the result using a morphological processing;
f) labeling the resulting binary image into foot and smart device sections; and
g) finding the object of interest nearest the center.
   Supplemental segmentation discriminators may also be used as well, including other color information channels such as Cb or the “a or b” value in the L-a-b color scheme, or edge discriminators or other techniques.

In one embodiment, the remote server may then determine a reference dimension of the identified smartphone in each photo of the received one or more photos (step 112). The reference dimension may be a height (H), width (W), and/or diagonal (D) of the smartphone itself (See FIG. 3), a screen dimension of the smartphone, and/or any other identifying reference, e.g., known smartphone case, logo, etc.

In some embodiments, the user may not be holding the smartphone in an ideal position, e.g., the screen may not be perpendicular to a plane of the reflective surface used to take a selfie. The server may correct the position of the smartphone by using an affine transformation to correct the image via translation, scale, shear, and/or rotation. The affine transformation may also allow a “best fit” rectangle to be determined even if a portion of the rectangle is obscured, e.g., by a user's fingers 302 (FIG. 3) or other such imperfections. The server may reference a device database for a measurement corresponding to the identified smartphone or other service pre-determined reference object measurement. This reference dimension may be set, by the server, as the reference dimension. In an alternative embodiment, the relevant programming and processing otherwise provided by a remote server to determine the reference dimension may be provided by the smartphone itself.

The exemplary method 100 may then include determining, by the server, at least one measurement-of-interest of the user based on the determined phone reference dimension (step 114). As used herein, “measurement-of-interest” may mean the linear length of a user's chest, waist, sleeve length or other body part included in the photo, with such measurements-of-interest available for determining or otherwise calculating body portions to be sized by the user for the purchase of garments, footwear, or other items where proper sizing is desirable. For example, a linear length of a user's chest may be a measurement-of-interest to be determined from a photo, but would not be used as a surrogate for commercially understood “chest size.” Rather, the chest length would be used in an estimate or to determine the chest size. The server may then determine the other sizing-related measurements of the user that may not be directly measurable in the two-dimensional photo but advantageous to properly size a to-be-purchased an item, e.g., an ellipsoid circumference of the user's chest and waist that may serve as a desired garment chest and west size. In some embodiments, the server may determine the user's body type and/or create a body type profile to facilitate sizing estimates when not all measurements-of-interest may be found or calculated from the photo. In an alternative embodiment, the user is presented with a selection of body types from which to choose to aid in the sizing determination process. The server may utilize the body type and/or body type profile in measurements-of-interest of users having a very skinny body type, a very obese body type, and/or an average body type.

The exemplary method 100 may then include sending, by the server, the determined sizing information to the smartphone and/or a e-tailer, reseller, or other on-line seller (“seller”) (step 116). If sent to the third-party seller, further processing steps may be performed, such as presenting the user with an alternative selection of items matching the at least one measurement, such as a selection of shirts, jackets and sweaters that have a manufacturer's cut that matches the sizing of the user.

FIGS. 2A and 2B depict exemplary front and side photo positions, respectively, that may be used for remote measurement of a user for fitting a men's polo shirt 200. The front photo position 202 is a selfie of a front view of a man's torso. The second photo position 204 is a selfie of a side view of a man's torso. The smartphone 206 is visible in both selfie photo positions (202, 204) to provide a known length (i.e., a reference dimension) after look-up with a known database of smartphones and associated dimensions. In certain embodiments, the server that receives the image and associated image data is hosted, controlled or otherwise used by an seller that may have or be able to access a database of smartphones or other common articles and associated dimensions. The database may be maintained and upgraded as new products become available. For example, the front or back of a cell phone 300, such as that illustrated in FIGS. 3A and 3B, respectively, may have a width (W), height (H), diagonal length (D), and sweep (SW). Other phone dimensions may be used as a reference dimension, however, such as the vertical, horizontal or diagonal dimensions of an active display area or the known dimension of any logo, button, soft key, and/or icon of the device. This allows the process to work with both front-facing and rear-facing camera selfies.

In one embodiment, only the front photo position 202 is used to determine chest and wait sizing. In this embodiment, two measurements-of-interest, such as the linear chest width (Chest_{w}) and waist width (Waist_{w}) (identified in FIG. 2A), enable the ellipsoid circumference (perimeter) of the chest 208 and waist 210 to be estimated. The measurements of overall shirt length 212 and sleeve length 214 may also be included and determined by comparison to the smart device reference dimensions included in the photo. In part because one or more of the user circumferences (208, 210) may be inferred and estimated based on user body type, a single front-facing image may suffice for certain user measurements.

In a second embodiment, such as to improve the estimates of chest and waist sizing for purchase of a shirt or other upper garment, the prospective customer may take the second selfie 204 in a mirror that captures the customer's side torso to capture chest depth (Chest_{D}) and waist depth (Waist_{D}). The smartphone application or server software may then perform the mathematical calculations using those determined measurements-of-interest to determine the right size polo shirt for the user. The measurement of a chest size, waist size or other body dimension of the user may require the calculation of the ellipsoid circumference (perimeter). In one embodiment, for relative precision, error of less than 100 ppm, and ease of calculation, the smartphone application or server software may use the well-known Sykora approximation:

$${S}^{′} ( a , b ) = 4 \frac{π ab + {( a - b )}^{2}}{a + b} - \frac{1}{2} \frac{ab}{( a + b )} \frac{{( a - b )}^{2}}{[ π ab + {( a + b )}^{2} ]} , \\ {E}^{′} ( x ) = \frac{π y + {( 1 - y )}^{2}}{1 + y} - \frac{1}{8} \frac{y}{( 1 + y )} \frac{{( 1 - y )}^{2}}{[ π y + {( 1 + y )}^{2} ]}$$

The above Sykora equation may be used to determine a perimeter (circumference) of an ellipse. The x,y version is for ellipses whose center is displaced from the origin. For other linear measurements, such as sleeve length, pants inseam, or foot length, the calculation may be determined by the proportional relationship between lengths of the device and the associated reference dimension, and the length determined in image analysis. One reference dimension is adequate for all of the image elements to be measured. The device does not need to be exactly horizontal, or vertical, because the smartphone application or remote server may optically sweep the display to either find one edge or, if the customer obscures a portion of the device, finds the shortest segment that runs across the device (See FIG. 3).

FIGS. 4A, 4B, and 4C depict side, front perspective, and bottom views of exemplary photo positions used to remotely determine measurements-of-interest of a man's foot for proper shoe sizing. In FIG. 4A, the users foot 400 may be positioned in front of a mirror 402, with the smartphone 404 also positioned such that the resulting image contains both the foot and smartphone. In FIG. 4B, the user repositions the foot and smartphone to capture a front of the user's foot with the smartphone in the resulting image. In FIG. 4C, a bottom of the users foot is captured in the smartphone image. In an alternative embodiment, the smartphone may also be positioned to be included in the smartphone image. Taking a selfie with a smartphone and a foot allows precise determination of a user's foot length and arch (depending on the view) for best fit.

FIG. 5 is a flowchart of an exemplary method of obtaining accurate remote measurements for use in making an on-line purchase of footwear. A user may take a selfie that includes the user's smartphone image and an inner side view of their foot (i.e., showing their arch) (step 500), taking care to include the user's foot arch in the photo. A second selfie may be taken that also includes the user's smartphone and with a front view of their foot included in the image (step 502). In other embodiments, rather than taking selfies, either the inner side view of the user's foot or the front perspective view of the user's foot or both may be taken with some other smartphone included in the photo (not the smartphone taking the photo) or other service-predetermined object (step 504). The foot and smartphone may then be identified in the photo by the smartphone application or remote server, and the reference dimension determined (step 506). With the images captured and available for image processing and with the reference dimension in the images determined, at least one measurement of the user's foot is determined, such as the length and width of the user's foot (step 512). For example, the user's foot length (shoe size), arch height, arch acme location, talus height, talus slope and toe cap height may be determined by the remote server from the reference dimension and the side view of the user's foot. From the front view, the width of the user's foot may be determined by scaling the width against the known dimension of the smartphone. In an alternative embodiment, such calculations are performed by the smartphone application itself or in combination with the remote server. Either case, the measurements of the user may be sent to a third-party retailer or reseller (step 514) and such third-party retailer or reseller may respond with an indication one or more products or footwear having the determined size for purchase (step 516). As used herein, a “front view” may not be a true front view, but may be a front perspective view. Similarly, side and bottom views may mean side perspective and bottom perspective views, respectively, with the practical limitation of being able to image the measurement-of-interest. The image processing steps described above may be performed either in a remote server, local server or in the smartphone itself.

The database of smartphone devices accessible by the remote Server or smartphone application may hold the overall dimensions included smartphone, e.g., a Galaxy 4 branded smartphone is 5.6″ tall and 2.9″ wide, to identify the imaged smartphone and for use as reference dimensions.

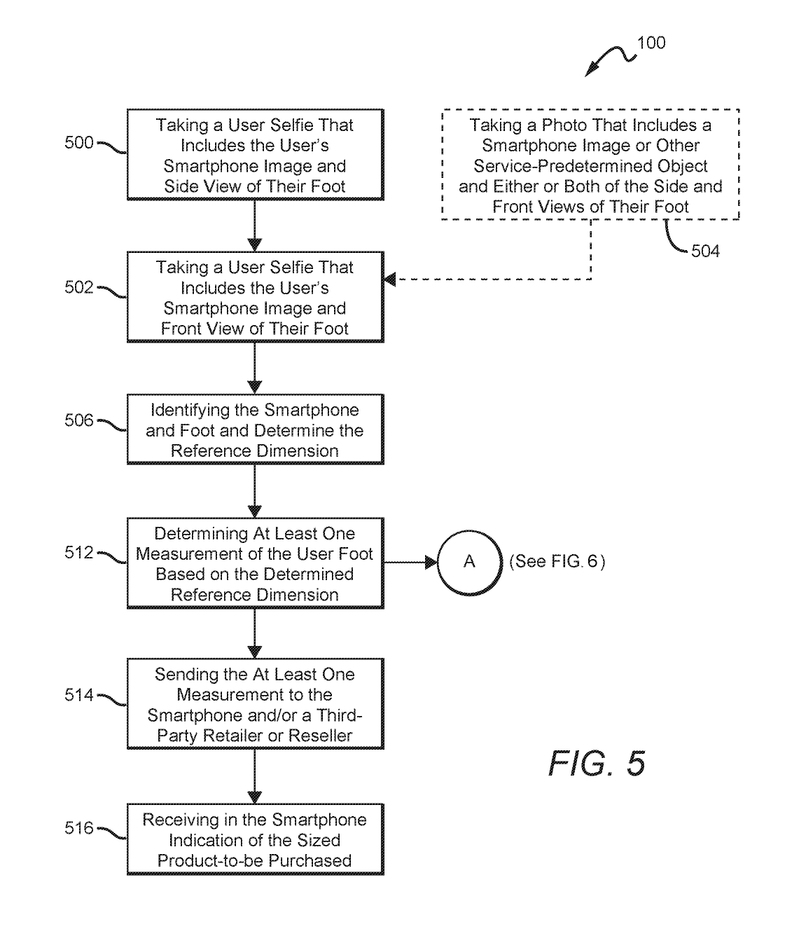

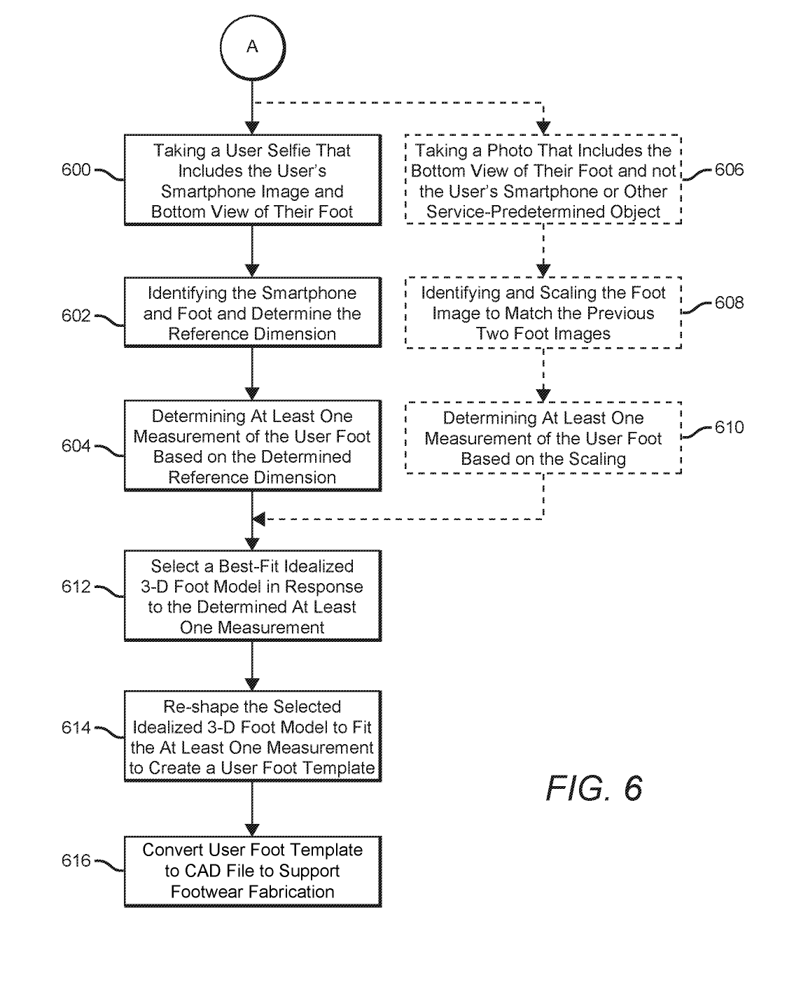

FIG. 6 is one embodiment of a method of building a 3-D model used in the construction of 3D models of certain body parts such as for making custom made footwear or specific parts of footwear. In this embodiment, a third selfie may be taken that includes a bottom view of the user's foot and smartphone (step 600). The smartphone and foot is identified and the reference dimension determined (step 602). At least one measurement of the user foot may then be determined based on the determined reference dimension (step 604). In an alternative embodiment, the photo of the foot does not also include an image of the user's smartphone or any other service predetermined object (step 606). Instead, the foot is identified in the image and then scaled to match the previous two foot images (step 608) (see FIG. 5, steps 500, 502). In such an embodiment, at least one measurement of the user foot is then determined based on the scaling (step 610) rather than identifying, segmenting and then using a reference object in the image.

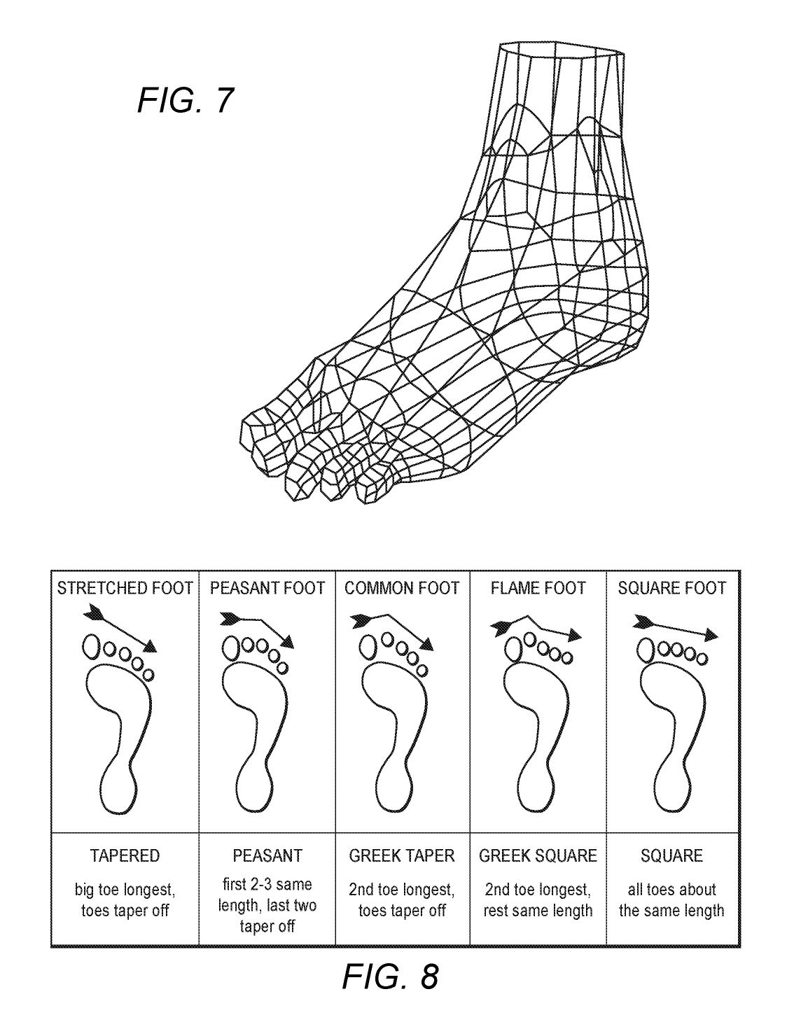

The three images are composited using proprietary software and an assembled database of reference foot shapes. This database takes advantage of the fact that though feet vary in individual measurements, they can be categorized by certain essential features. Virtually all feet have the big toe, the second toe or the third toe as the extreme length point. Virtually all feet have either flat toe heights or curled toes where either the first or second joints are the highest point from the toe connections to the toe tip. By assembling this matrix of characteristics, a table can be assembled and the foot can be identified by its closest match. to one or more pre-existing idealized 3-D foot models to select a “best fit” for such models (step 612). For example, all feet have a generalized form (see FIG. 7) such that an idealized 3-D model of a foot or a series of standard feet may be established. In one embodiment, a generalized form (see FIG. 7) may be further modified to fit five standard idealized foot types (i.e., tapered, peasant, Greek taper, Greek square, square models) (FIG. 8). Subsequent to selecting the “best fit” (step 612), the Server or application may re-shape the selected idealized 3-D foot Model to fit the at least one user measurement to create a user foot template (step 614). This 3D model foot template can be used as a virtual shoemaker's last around which a custom shoe or sneaker may be fabricated. Similarly to old techniques for using a last as a template for stretching, shaping and sewing a shoe, this virtual 3D model may be exported as an STL (stereo lith) or other file which can be rotated for viewing and analysis, fleshed out with suitable space margins for socks and foot space and provided to an additive manufacturing tool such as a 3D printer or numerically controlled machine for fabricating all or some of the parts of a shoe, sneaker or other foot fitted item (step 616). This process may eliminate the complex “wire mesh” or “rigid surface” matrix mathematics involved in other 3D constructs.

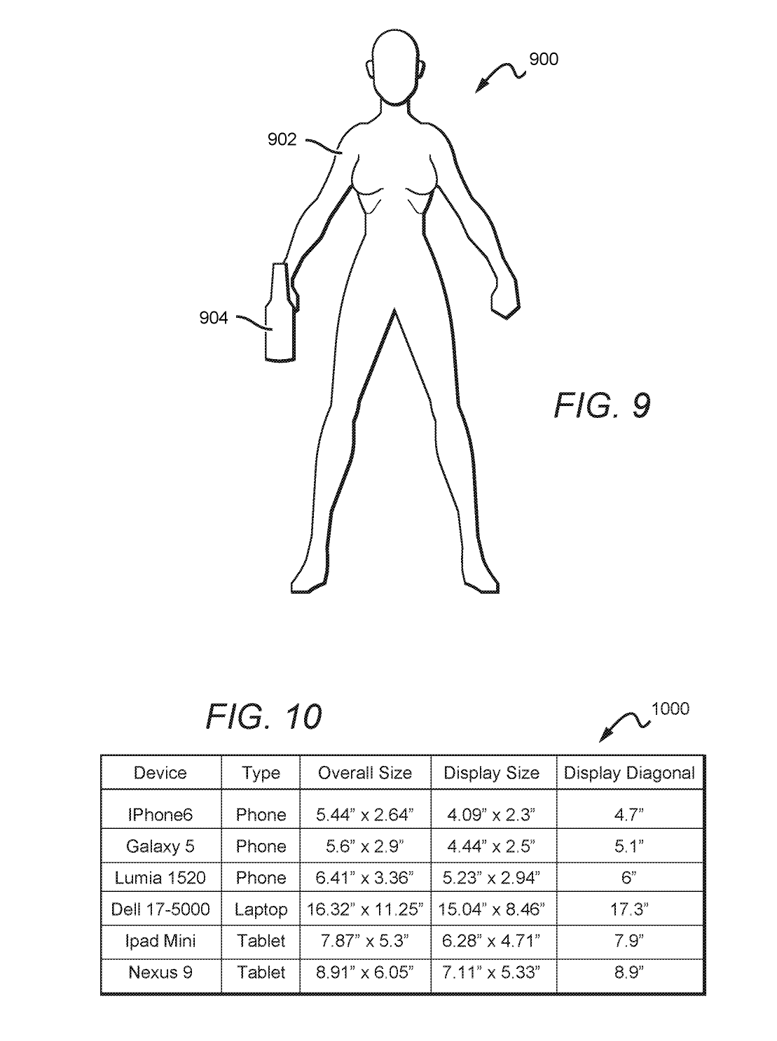

FIG. 9 depicts a photo with a reference object selected from a group of service-predetermined objects that may be used to remotely determine a reference dimension of the reference object in order to remotely determine a user's measurements 900. The woman 902 is depicted as holding a soda bottle 904, which has known dimensions for the fitting service described herein (i.e., a system pre-determined reference object). The program may thus use the soda bottle to identify a reference dimension. The program may reference a database for a measurement corresponding to the identified reference dimension, and set the measurement as the reference dimension. Accordingly, the program may determine one or more user measurements by using the reference dimension. A standard object commonly available at a customer location and mutually agreed-upon by the user and a third-party, such as a vendor, may be used (i.e., a “service predetermined object”). Service predetermined objects may include A4 paper, letter-sized paper, a specific soft drink container, a ruler, a yardstick, or any other pre-determined reference objects having fixed and known dimensions.

FIG. 10 depicts a sample database for determining the dimensions of a reference dimension of an identified smartphone or other object 1000. The database of smart devices incorporates the mechanical dimensions of various cameras, or viewfinder equipped phones, tablets, netbooks, laptops, watches and any other system pre-determined reference object equipment. The Smartphone may be queried

via the Application Program Interface within the app so the smartphone can be identified.

The program may also utilize a fixed dimension of any shape provided by the program which can be made to appear on the display. The database may have any number of parameters. In some embodiments, the database may have five parameters, including: the overall length of the smart device; the overall width of the smart device; the overall length of the display of the smart device; the overall width of the display of the smart device; and the diagonal measurement of the display of the smart device.

Template for the Apparel Database

The measurements may correlate with an extensive database of enhanced apparel and footwear measurements. This database might contain the fitting parameters of many thousands of products. It then becomes possible to match the measurement parameters of the customer to the best products chosen for style, cut and fit from among the products offered by the vendor. In this way, a customer who cannot try on the specific product is able to purchase the best products selected by the database management system from a wide array of choices.

The data base could, for example, contain the following measurements for pants:

### Category Pants

| Item | Waist | Inseam | Thigh inner perimeter | Calf inner perimeter |
|---|---|---|---|---|
| XYZ | 34″ | 32″ | 21″ | 14.5″ |

A woman's blouse category could be as follows:

### Category Woman's Blouse

| Item | Neck | Length | Sleeve | Bust perimeter | Waist perimeter |
|---|---|---|---|---|---|
| ABC | 14″ | 23″ | 27″ | 35″ | 29″ |

The database management system may match the parameters of the selfie so that the blouse recommended would be equal to or greater than the required fit size for the customer and may also show the selected parameters to the customer prior to purchase.

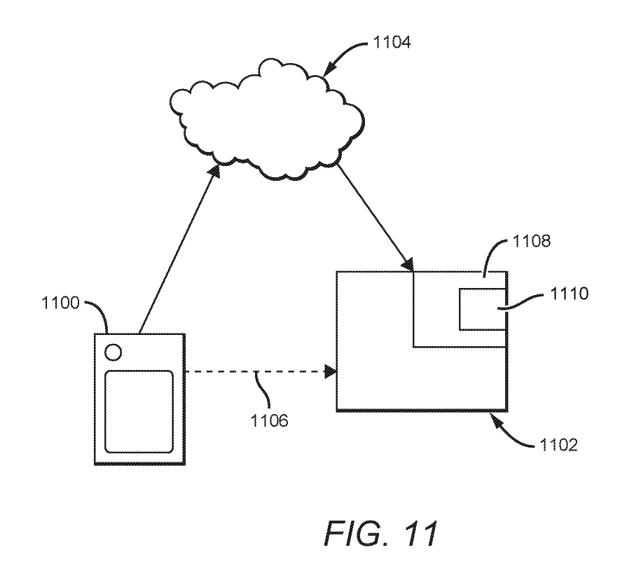

FIG. 11 illustrates a server in communication with a smartphone for image processing. The smartphone 1100 may be in communication with the server 1102 either through the Internet 1104 or, if the server is local to the smartphone, through a local access network (LAN), directly through a wired connection or by other means (collectively 1106). The server 1102 may have a processor 1108 and addressable memory 1110 that are capable with suitable programming to perform the steps illustrated in at least FIGS. 1, 5, and 6.

It is contemplated that various combinations and/or sub-combinations of the specific features and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A method, comprising:
receiving, by a server having a processor and addressable memory, a first image and a first image data from a smartphone, wherein the first image contains a system-predetermined reference object and at least a portion of a user;
identifying, by the server, the system-predetermined reference object in the first image;
determining, by the server, a first reference dimension of the identified system-predetermined reference object in the first image; and
determining, by the server, at least one measurement of the user based on the determined first reference dimension.

2. The method of claim 1, wherein the system-predetermined reference object is a smartphone that created the first image.

3. The method of claim 2 further comprising:
receiving, by the server, a second image from the smartphone, wherein the second image contains the smartphone that created the second image and at least a portion of the user;
determining, by the server, a second reference dimension of the identified smartphone in the second image; and
determining, by the server, at least one measurement of the user based on the determined second reference dimension.

4. The method of claim 2 wherein the first image comprises at least one of: a selfie of the user containing a front view of the user's torso, a selfie of the user containing a side view of the user's torso, a selfie of the user containing a front view of the user's foot, and a selfie of the user containing a side view of the user's foot.

5. The method of claim 2 further comprising:
taking, by the smartphone of the user, the first image with the smartphone.

6. The method of claim 2 wherein identifying the smartphone is based on the first image data.

7. The method of claim 5 wherein the first image data comprises the identity of the smartphone selected by the user.

8. The method of claim 5 wherein the first image data comprises metadata identifying the smartphone model.

9. The method of claim 2 wherein determining the first reference dimension of the identified smartphone in the first image further comprises:
identifying, by the server, a smartphone measurement in the first image;
referencing, by the server, a device database for a measurement corresponding to the identified smartphone measurement; and
setting, by the server, the identified smartphone measurement as the first reference dimension based on the referenced device database measurement.

10. The method of claim 1 wherein determining at least one measurement of the user based on the determined first reference dimension further comprises:
calculating, by the server, an ellipsoid circumference of the user via a Sykora approximation.

11. The method of claim 1 wherein the determined at least one measurement of the user is at least one of: a chest measurement, a waist measurement, a sleeve length, a pants inseam, a foot length, and a foot arc.

12. The method of claim 11, further comprising:
sending the at least one measurement of the user to a third-party retailer.

13. The method of claim 11, further comprising:
sending the at least one measurement of the user to the smartphone.

14. A method, comprising:
taking front and side smartphone photos of a user's foot, the front and side smartphone images including an image of a system-predetermined reference object.

15. The method of claim 14, further comprising:
taking a photo that includes a bottom view of the user's foot.

16. The method of claim 15, further comprising:
identifying the system-predetermined reference object and determine a reference dimension for the system-predetermined reference object.

17. The method of claim 16, further comprising:
determining at least one measurement of the user foot based on the determined reference dimension.

18. The method of claim 17, further comprising:
selecting a best-fit idealized 3-D foot model in response to the at least one measurement.

19. The method of claim 18, further comprising:
re-shaping the selected idealized 3-D foot model to fit the at least one measurement to create a user foot template.

20. The method of claim 19, further comprising:
providing the user foot template to an additive manufacturing tool; and
manufacturing a footwear article that is sized to fit the user foot template.
